(19) United States
(12) Patent Application Publication
(10) Pub. No.: US 2013/0091557 A1
(43) Pub. Date: Apr. 11, 2013

(54) SYSTEM AND METHOD FOR PROVIDING CLOUD-BASED CROSS-PLATFORM APPLICATION STORES FOR MOBILE COMPUTING DEVICES

(71) Applicant: WHEEL INNOVATIONZ, INC., Austin, TX (US)

(72) Inventor: Srini Gurrapu, Austin, TX (US)

(73) Assignee: WHEEL INNOVATIONZ, INC., Austin, TX (US)

(21) Appl. No.: 13/650,011

(22) Filed: Oct. 11, 2012

Related U.S. Application Data
(60) Provisional application No. 61/545,916, filed on Oct. 11, 2011.

(51) Int. Cl. G06F 21/00; G06F 15/16

(52) U.S. Cl. 726/5; 709/225

(57) ABSTRACT

A method of accessing an application on an internet computing device includes deploying a cross-platform application store server, and accessing one or more multi-platform applications in either of two modes: a first mode including running in a cloud one or more multi-platform applications in an application container, and remotely displaying the applications using a display protocol, or a second mode including running by proxy one or more local applications on a device in a secure application container.

### CROSS-REFERENCE TO RELATED APPLICATIONS

This application claims priority under 35 U.S.C. §119(e) to U.S. Application Ser. No. 61/545,916, filed Oct. 11, 2011, which is included by reference in its entirety herein.

### BACKGROUND

A. Field

Embodiments described herein relate generally to cloud-based technologies and cross-platform application stores for internet computing devices.

B. Background

Applications, or simply “apps,” for mobile computing devices have increased in availability and popularity in recent years. While personal computer (PC) applications still have the largest market share in terms of dollars, an overwhelming number of new apps have been developed for mobile computing devices. As a result of this trend, users care less about the operating system, or OS, on their mobile device, and more about what apps and personal data they can use on their mobile device.

Apple's iPhone™ has been a major driver in the increase in popularity of mobile apps. However, the iPhone™ platform is also the cause of one of the most significant problem involving apps, which is that the proprietary nature of apps allows that each app only works on one platform (i.e., mobile computing device OS, e.g., iOS, but not others such as Windows Mobile, Android, etc.). End users and businesses often need to use apps built on different platforms such as Windows, Linux, SaaS, iOS, Android, etc. Consequently, the apps must be developed, separately for each individual platform in order to be accessed by users of the different platforms. One version of an app simply will not work on two different types of platforms.

Similarly the proprietary nature of the iOS platform and the consumer focus results in big security exposure for enterprises (business customers) to deploy their apps on the user's devices—a theme also known as BYOD (Bring-Your-Own-Device). The iOS platform does not have the security features to have data encryption, authentication and authorization (AA), network security features and other policy controls that reflect the business needs to protect their data, users and adhere to corporate and regulatory compliance. Please note that the iOS platform [and other mobile platforms] security features are built with consumer focus with device level encryption and security features that does not meet the needs of enterprise customers. Nonetheless, the app store market has been very lucrative for platform providers. Users want apps for their computing devices, and platform providers may lose customers when apps are not available for their platform.

End users typically cannot deal with the complexity involved in providing various technologies across different apps in current cross-platform solutions. Techniques such as running “natively, securely in a separate secure sandbox” on a device, emulation, application virtualization, containerization, remote display methods, and virtual machines have varying consequences in terms of the application delivery cost, compute resources, licensing, security, user experience and performance.

Accordingly, there exists a need for a system and method that allows users, regardless of their computing device and platform, to use their apps and personal data that meets the security, availability and cost measures

### SUMMARY

In one aspect, embodiments disclosed herein relate to a method of accessing an application on an internet computing device including deploying a cross-platform application store server, and accessing one or more applications in either of two modes: a first mode comprising running in a cloud one or more multi-platform applications in an application container, and remotely displaying the applications using a display protocol, or a second mode comprising running by proxy one or more local applications on a device in a secure application container.

In other aspects, embodiments disclosed here relate to an Internet computing device including, an application that is deployable in either of two modes: a local mode configured to create a secure application container and proxy for local applications to run on the device, or a cloud mode configured to run in an application container and remotely display multi-platform applications on the device.

In yet other aspects, embodiments disclosed herein relate to an application platform for running on an internet computing device including a desktop provisioning service module that is configured for provisioning individual desktops for users, an application publishing service module configured to allow delivery of Windows apps and Linux Apps to users, an aggregation service module configured to allow publishing of software-as-a-service applications into an appliance, and a user store service module configured for provisioning a native user store or connecting to any available external user stores.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment.

FIG. 1 illustrates a screenshot from an end user perspective of the AppTop platform in accordance with one or more embodiments of the present disclosure.

FIG. 2 illustrates a deployment architecture of the AppTop platform in accordance with one or more embodiments of the present disclosure.

FIG. 3 illustrates a screenshot of the AppTop app in accordance with one or more embodiments of the present disclosure.

FIG. 4 illustrates a user authentication process in accordance with one or more embodiments of the present disclosure.

FIG. 5 illustrates various modes that the AppTop cross-platform appstore server presents to an end user to access apps in accordance with one or more embodiments of the present disclosure.

FIG. 6 illustrates an AppTop Local mode in accordance with one or more embodiments of the present disclosure.

FIG. 7 illustrates wrapping techniques of individual apps in accordance with one or more embodiments of the present disclosure.

FIG. 8 illustrates an AppTop Proxy method for securing native and public app store apps that cannot be wrapped in accordance with one or more embodiments of the present disclosure.

FIG. 9 illustrates an AppTop Cloud mode in accordance with one or more embodiments of the present disclosure.

FIG. 10 illustrates an App-Delivery-Fit process in accordance with one or more embodiments of the present disclosure.

FIG. 11 illustrates a marketplace of App Publishers, App Delivery techniques and cloud computing providers using the App-Delivery-Fit process of FIG. 10 in accordance with one or more embodiments of the present disclosure.

FIG. 12 illustrates the internal architecture of the cross-platform app store server (Wheel Manager) in accordance with one or more embodiments of the present disclosure.

FIG. 13 illustrates an initial or home interface provided by an application implementation of the cross-platform app store in accordance with one or more embodiments of the present disclosure.

### DETAILED DESCRIPTION

Described herein are embodiments of a system and method for providing cloud-based cross-platform application stores for internet computing devices (i.e., computing devices with Internet access). Embodiments provide cloud-based, cross-platform application stores that enable users, regardless of their computing device and platform, to use their apps and personal data on their internet computing device.

One or more embodiments provide a cloud-based cross-platform application store that may be run on any internet device, including emerging tablets such as iOS, Android, ChromeBooks, and traditional PCs, Workstations, ThinClients and Macs, etc. The applications that may be supported include, but are not limited to, Windows, Linux, SaaS, OSX, Android, iOS, and other emerging platforms with which one of ordinary skill in the art will be familiar. The application store may be run on any cloud (either public or private) and on any service provider network. As used herein, cloud computing or cloud-based may be refer to the use of computing resources (hardware and software) that are delivered as a service over a network (e.g., the Internet).

One or more embodiments provide a cloud-based application orchestration platform (which may be referred to as “Universal Cloud Application Broker Service” (U-CABS)) that provides an appropriate application delivery mechanism based on certain criteria, which include, but are not limited to (a) type of user, device, and the type of network connection; (b) application coverage (i.e., ability to run the application without any issues); and/or (c) “best economics.” Rest economics, as used herein, may refer to choosing a provisioning mechanism that results in the low-cost method that takes into the account costs such as licensing fees, cloud computing resources, location and proximity of the cloud computing resources, and other delivery technologies that are used in the solution while meeting the guaranteed service-level agreement (SLA) and security requirements.

Some examples of guaranteed security requirements may include, but are not limited to: 1) Data protection both at rest and on the wire; 2) network security controls; 3) authentication and authorization; and 4) detailed auditing. Some examples of the service levels may be, but are not limited to: 1) access to the application when the user's device is offline from the network (i.e., AppTop Local mode) or online with the network (i.e., Appstore server) with a desired user experience with HTML5.

In addition, the user experience may be tailored/adapted to individual device capabilities, including, but not limited to global positioning systems (GPS), gestures, and location of the user. Embodiments may use the U-CARS to provide an appropriate technique for delivering applications for each type of application. These techniques or processes may be referred to as “App-Delivery-Fit,” which will be described below in detail (FIG. 10).

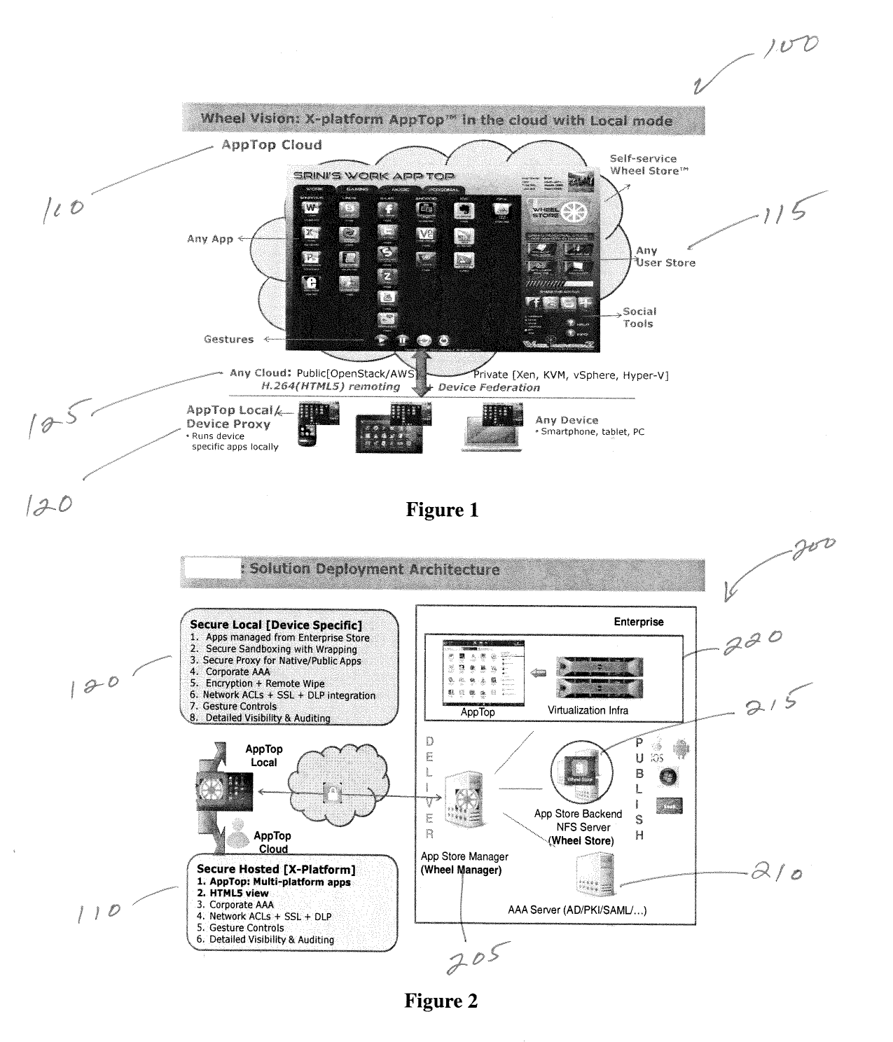

One or more embodiments provide varying application delivery modes that allow different mobile applications to be run securely on the device or run in a Cloud, and which maximize the security and cost-efficiency for users. Referring to FIG. 1, a screenshot 100 from an end user perspective in accordance with one or more embodiments of the present disclosure is shown. The following is a description of the components as seen by the end user. “AppTop Cloud” 110 runs multi-platform apps using one or more of a combination of emulation, simulation, terminal services or virtualization. Different applications may be delivered using different technologies. For example. Windows Apps may be delivered using terminal services in the simple Publish Apps mode and may be run on any device with delivery (i.e., cost and user experience) optimized based on the device. Android Apps may be run on any device, with cost and user experience optimized based on the device, using a high-performance Android emulator that runs on X86 Linux Virtual Machines. Further, SaaS Apps may provide SSO (“single sign-on”), unified access control, and data in/out security. Linux Apps may use a combination of terminal services and local execution on AppTop VM. Finally, iOS Apps may run on any device using a combination of simulators.

An “Any User Store” 115 is for user and app specific data and provides Native drive and securely connects to third party drives such as, but not limited to, DropBox, SugarSync or other CloudStores. An “Any Cloud” Infastructure 125 provides flexibility and choice to customers. No solution components are tied to a specific hypervisor or cloud API, and the solution is optimized to minimize the cloud resources with app specific mechanism and device proxy.

“AppTop Local” or Device Proxy 120 runs device specific apps locally to improve user experience and minimize cloud costs. AppTop Local works when users do not have internet connectivity. To do so, AppTop Local creates a secure sandbox for the corporate applications on the device using wrapping technology, which will be understood by one of ordinary skill in the art. AppTop Local also creates a secure proxy on the device for those applications (i.e., typically native apps such as iOS mail client, mobile Safari or public app store apps). Embodiments disclosed herein may provide a “Rich User Experience” using H.264 and device federation multi-tenancy solutions for service providers, and/or H.264 and higher high-definition protocol, as will be understood by one of ordinary skill in the art.

Referring now to FIG. 2, deployment architecture of the solution in accordance with one or more embodiments of the present disclosure is shown. As shown, a customer deploys a cross-platform app store server known as “WheelManager” 205. WheelManager 205 connects to corporate AAA (Authentication, Authorization and Auditing) servers 210 for user authentication. Wheel Manager 205 connects to an enterprise storage such as NFS 215 for storing all the apps being delivered to the users, and to a virtualization or cloud platform to run AppTop Virtual Machines in the cloud. On the end user device, there is an “AppTop” app that is deployed which gives the users the ability to run and access various apps built on different platforms from their device either locally (i.e., AppTop Local 120) or from the cloud (i.e., AppTop Cloud 110).

In one or more embodiments disclosed herein, different techniques may be used to deliver apps in either the AppTop Cloud 110 and AppTop Local 120 modes. The AppTop Cloud mode 110 may be used to run multi-platform apps in an AppTop container that is remote displayed using HTML5 or other display protocol to be accessed from any device. AppTop Cloud mode 110 may use emulation (typically for Android, simulation (typically for iOS), Terminal Services and OS/App Virtualization (typically for Windows & Linux), and/or SaaS gateway (typically for Web/SaaS Apps).

The AppTop Local mode 120 may be used to create a secure container and proxy for local apps to run on the device. AppTop Local mode 120 may use App Wrapping for security and delivering apps, typically when the customer has a binary to wrap to. AppTop Local mode may also use AppTop Proxy Plug-in architecture for securing native and public apps that cannot be secured or delivered using App Wrapping, or when the customer does not have access to the binary. AppTop also creates a single container (i.e., enterprise secure container) 220 for all the apps regardless of the platform that is isolated from the rest of the stuff on user device.

In the following section, the various modes are described in detail with screen shots of a working design and application for AppTop Cloud mode 110 and AppTop Local mode 120, the architecture of the X-platform app store platform, and the “App-Delivery-Fit” algorithm in accordance with one or more embodiments of the present disclosure.

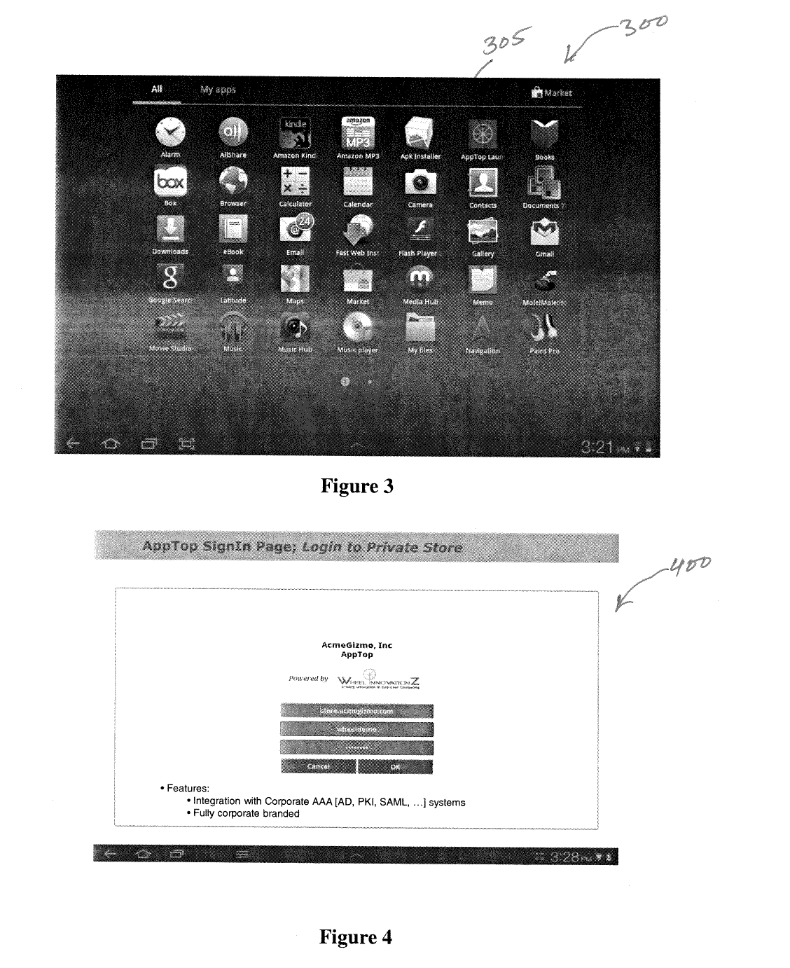

Referring now to FIG. 3, a screenshot 300 of an end user experience accessing the “AppTop” app that provides a secure and cost-effective way to access multi-platform apps securely on their device in accordance with one or more embodiments of the present disclosure is shown. In FIG. 3, AppTop (AppTop Launcher 305) is the app that the end user uses to access their apps.

FIG. 4 illustrates a screenshot 400 for user authentication against the cross-platform app store server WheelManager using their authorized credentials. A user must have proper authentication before being allowed access of the applications.

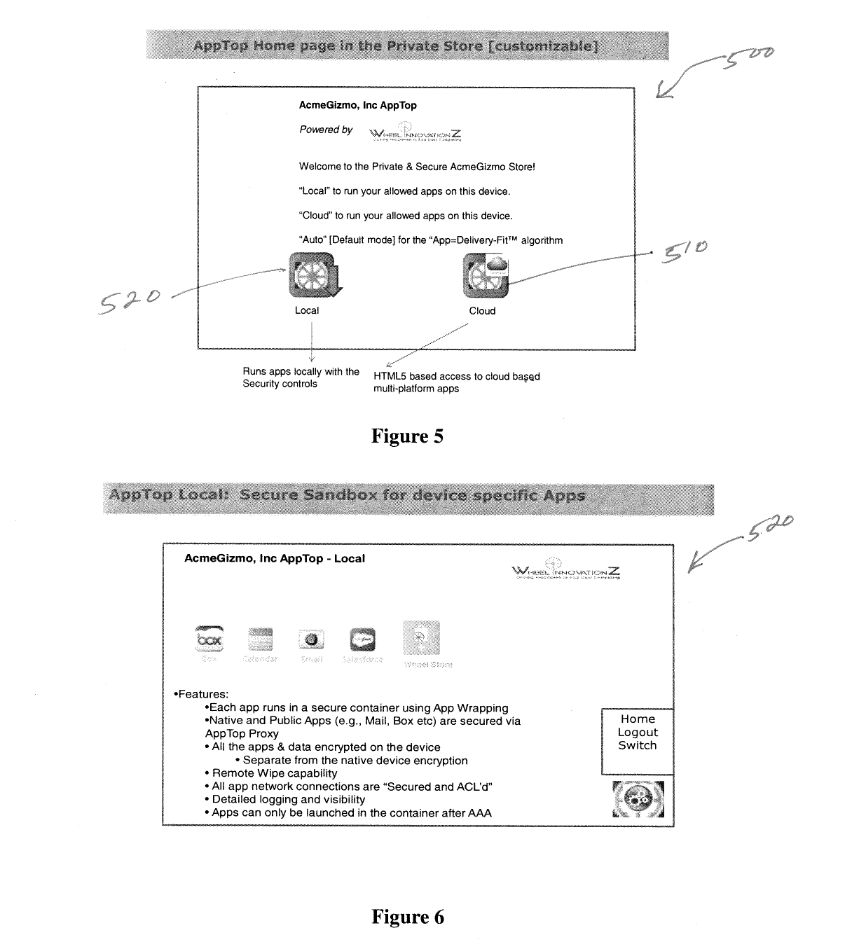

FIG. 5 depicts the various modes that the cross-platform appstore server presents to the end user to access their sanctioned apps on their device. As shown, a user may access a “local” mode 520 to run allowed apps on their device. Alternatively, a user may access a “cloud” mode 510 to run allowed apps on their device. The administrator of the App Store Server may choose to let the end user choose the mode, or the user could do an automatic selection of the mode based on the App-Delivery-Fit™ algorithm described in the FIG. 10.

FIG. 6 depicts the AppTop Local mode 520 where the select group of apps are accessed in a secure sandbox that is shielded from the rest of the user apps and data on the device. While a single container for all authorized apps may be accomplished on Android using a Launcher capability available on the Android platform, embodiments disclosed herein provide a single container for all authorized apps on iOS platform with a combination of URLScheme and dedicated IPC (i.e., interprocess mechanisms).

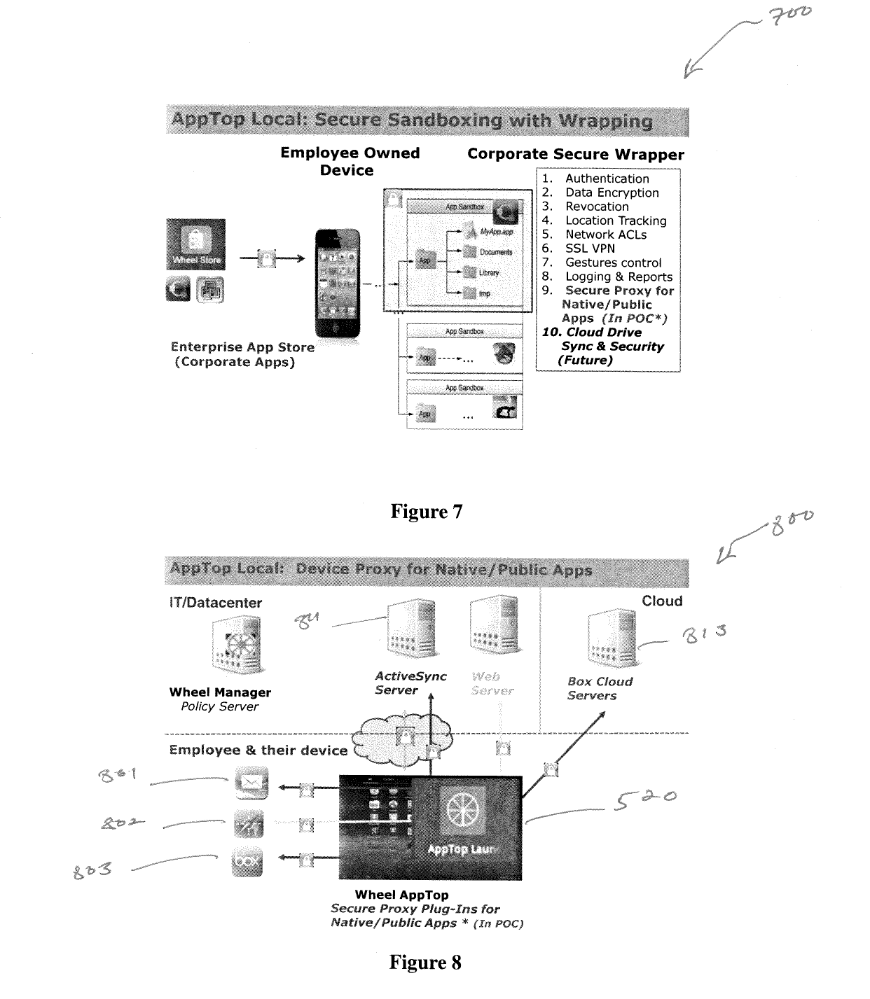

FIG. 7 depicts the specific technique of wrapping, individual applications 700 (where the customer has access to a binary) so that they may be securely deployed inside an AppTop Local secure container on the user's device. Each wrapped application may be hooked with a “SecurityDeliveryServices” library so that the application calls are intercepted to create security and delivery services specific to the platform.

FIG. 8 depicts the “AppTop Proxy” mode 800 for securing native and public app store apps that cannot be wrapped with the technique described in FIG. 7. In FIG. 8, the example apps (e.g., iOSmail client 801, mobile safari 802, and 3rd party box.net app 803) that reside on the device may need to be secured for data protection and network protection. As explained earlier, these apps are built-into the iOS platform (or other mobile platforms) or delivered from the public app store on to the device using DRM technology, and therefore, wrapping technology as explained in FIG. 7 may not work. Instead, embodiments disclosed herein provide a proxy plug-in concept.

A proxy plug-in workflow runs as follows: AppTop Local has proxy plug-ins for the desired native or public apps that speak the app specific protocol. The application may be configured to “talk” to the AppTop Local app instead of the external server (such as corporate ActiveSync/Exchange server or Box net cloud server). The application ma be configured to have the app talk to the AppTop using loopback addresses (e.g., 127.0.0.1) and URL schemes, as will be understood by one of ordinary skill in the art.

AppTop Local 520 is configured to talk to the external servers such as corporate ActiveSync/Exchanger server 811 or Box.net server 813. The external server is configured to not allow connections from the apps directly, but only from the trusted “AppTop Local” client with valid credentials. The AppTop Local 520 app also configures these said apps on the device to not store any data locally using a MDM (Mobile Device Management) like agent. For example, the mail client may be configured so that there is no archival allowed. This does not mean that the mail client cannot retrieve their email when there is no network connection to the external server. Because the mail client only talks to the AppTop Local Proxy plug-in, there is always connectivity and access to the email even when there is no connection to the external server.

AppTop Local 520, upon receiving, the data from the external server, encrypts the data and stores it in the “AppTop Local” sandbox. Any attachments received from the “external server” may also be encrypted by the AppTop so that only App'Top (or other trusted 3rd party plug-ins) may open the encrypted attachments. Mail client may then read email directly from the AppTop sandbox. AppTop decrypts the mail before serving it to the mail client. AppTop stores all the mail data and attachments encrypted in its local sandbox on the device: so even if a user has access to the device and unlocks it—they cannot access the email unless they authenticate into the AppTop secure container. The above mechanism works with other native and public apps with different app specific plug-in for different apps (e.g., box proxy plug-in, safari proxy plug-in, etc.). The above proxy mechanism guarantees the security of the data while giving the end users the choice to user their devices and their favorite apps.

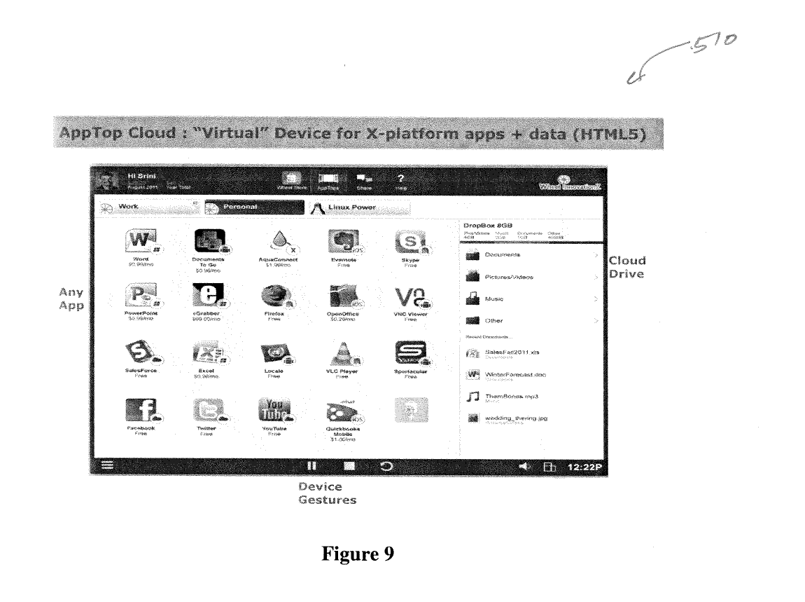

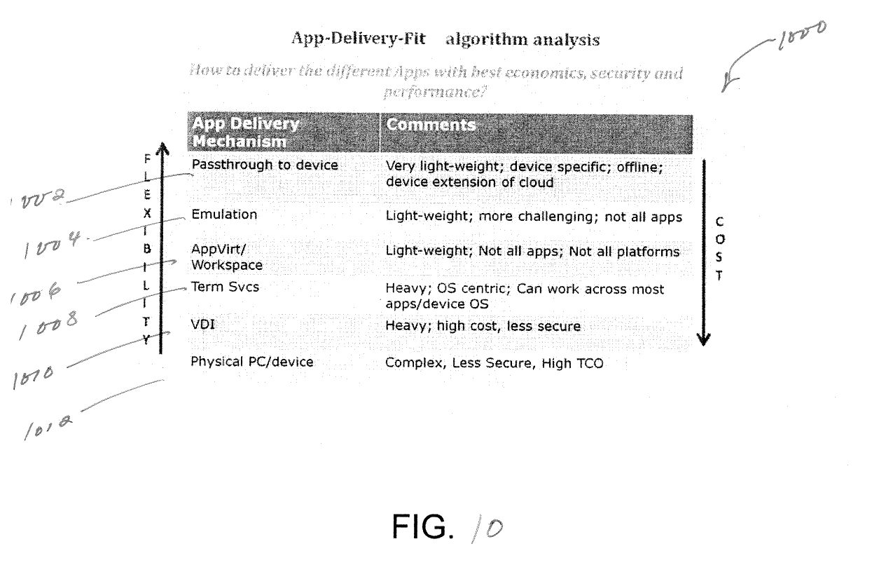

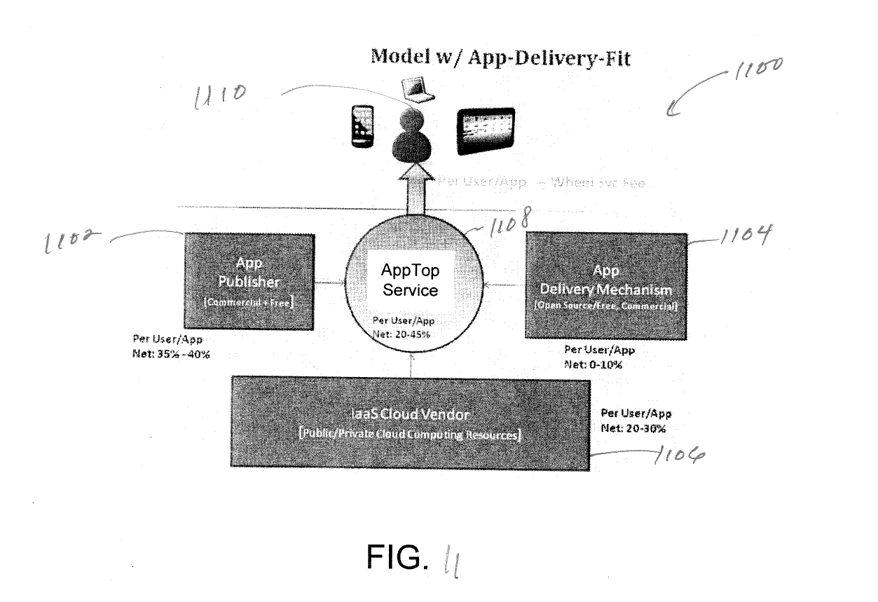

Referring now to FIG. 9, a screenshot of the AppTop Cloud deployment mode 510, where users may access any platform app from their choice of device, in accordance with one or more embodiments of the present disclosure is shown. As shown in FIG. 9, AppTop Cloud 510 is a Virtual Machine (Linux Micro Virtual Machine) that is built with emulators (typically for Android), simulators (typically for iOS run on a Mac. OSX machine accessed via a remote display client such as AquaConnect), terminal services (typically for Windows), SaaS Gateway connector (typically SaaS connector), and/or User Data Drive Connector (typically for Dropbox, Box.net or Google Drive etc). The AppTop Virtual Machine is designed such that users have access to their multiple platform apps and data on the main console (i.e., easy and quick access). To facilitate the platform type, each app icon is superimposed with a platform icon such as, but not limited to, Windows, iOS, Android. SaaS etc., so that users know how to interact with the application. The AppTop virtual machine also has HTML5 display service so that users can access this App fop Cloud Virtual Machine with multi-platform apps from any HTML5 device (i.e., typically every internet connected device now).

Now referring to FIG. 10, an App-Delivery-Fit process 1000 in accordance with one or more embodiments of the present disclosure described above is shown. Various app delivery mechanisms may be used, each of which exhibits a range of flexibilities inversely proportional to cost. For example, a “pass through to device” app delivery mechanism 1002 may be used, which is very light weight, device specific, occurs offline, and which basically renders the device as an extension of the cloud (i.e., used for AppTop Local mode). One or more of the remaining app delivery mechanisms may be used for AppTop Cloud mode. An emulation app delivery mechanism 1004 is light-weight, but is more challenging, and not suitable for all apps. An “AppVirt/Workspace” app delivery mechanism 1006 is also light-weight, but not suitable for all apps and platforms. A “Term Svcs” app delivery mechanism 1008 is heavy, OS centric, and may work across most apps and device operating systems. A “VDI” app delivery mechanism 1010 is heavy, high cost, and less secure. Finally, a “physical PC/device” app delivery mechanism 1012 is complex, less secure, and has a high TCO.

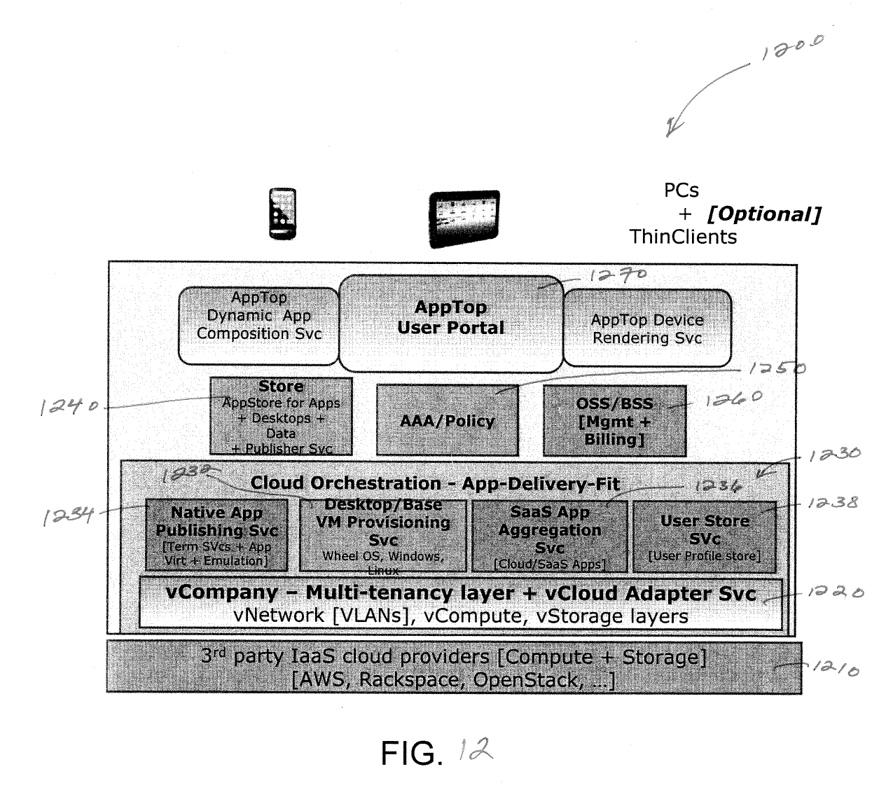

FIG. 11 depicts a marketplace 1100 of App Publishers 1102, App Delivery techniques 1104 and cloud computing providers 1106 using the App-Delivery-Fit process 1108 of FIG. 10 in accordance with one or more embodiments of the present disclosure. Thus, end users 1110 may experience low-cost, highly secure and ubiquitous access to applications on their choice of device. As such, embodiments disclosed herein provide a solution that delivers a range of all apps and user data on all devices using “App-Delivery-Fit” technology. In other words, embodiments disclosed herein use the “optimal” delivery technology for each application based on the type of end user context (i.e., device, location, type of app, etc.).

One or more embodiments may provide an OS-agnostic App service platform 1108 that delivers users a choice of applications (regardless of the application platform) and personal data from a wide range of data stores, which are provided from the cloud-based cross-platform application store. The AppTop user experience may be designed such that it may be run on any device while providing a convenient way to access users application and data. The AppTop platform may further provide granular details about the usage costs per hour for minute) to facilitate end-users with a transparent way to access the needed information and real-time usage charges.

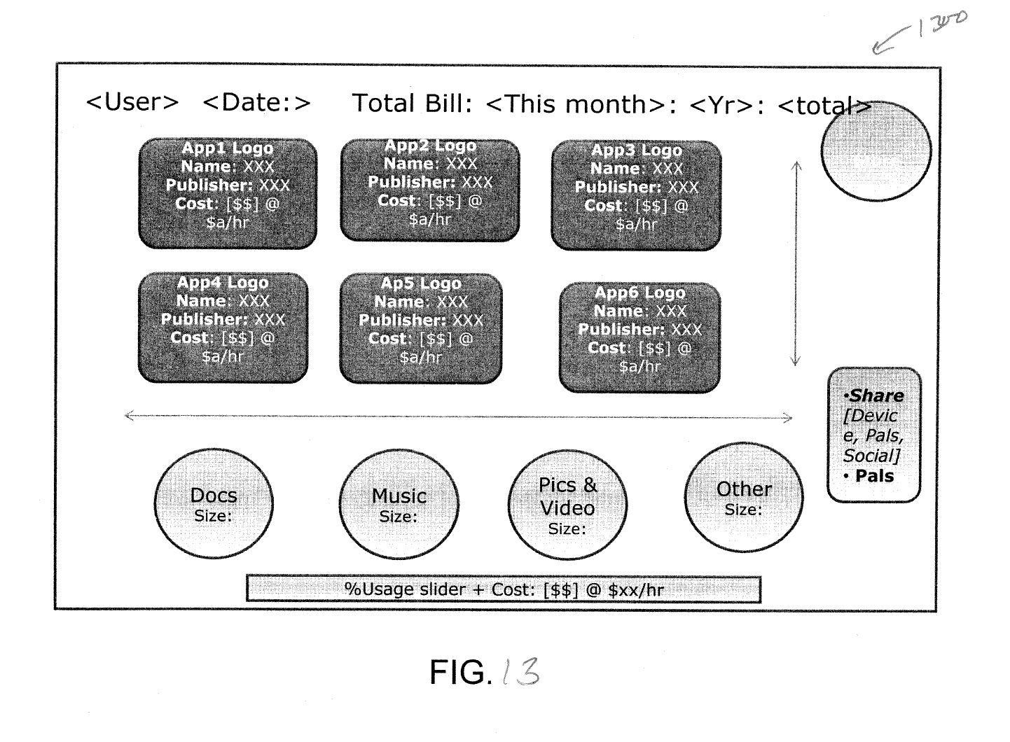

Referring now to FIG. 12, an internal architecture of the cross-platform app store server (i.e., Wheel Manager 205 shown in FIG. 2) for use in a multi-tenancy environment for service providers and enterprises in accordance with one or more embodiments of the present disclosure is shown. Third party cloud providers 1210 may be external cloud providers or services that provide machine instances (i.e., virtual servers) and storage (i.e., virtual storage) as the building blocks on which Wheel Manager described herewith runs. Other virtual services including, but not limited to, Virtual firewall, Virtual Load Balancer, Monitoring services and others may be used in accordance with one or more embodiments of the present disclosure. Embodiments disclosed herein may be built on the Amazon AWS (EC2 or “Elastic Computer Cloud”) infrastructure as well as Rackspace and OpenStack public cloud provider infrastructures. Embodiments may be designed to work with any third party cloud provider infrastructures, including private cloud infrastructures that run on any available hypervisors including, but not limited to vSphere, XenServer, Hyper-V, KVM, OpenStack, or other known hypervisors.

A Cloud Adapter and vCompany MT layer 1220 performs abstract vCompute, vStorage, vNetwork, vSecurity vOSS/BSS, etc. services with individual cloud specific API's plugged into it. Cloud Adaptor Layer 1220 ensures that services provided in one or more embodiments may be seamlessly plugged into any third party cloud service providers underneath by simply writing an additional adapter for the specific cloud provider. In addition, in embodiments that provide the service to SMB (“Small. Medium Business”) type customers, the Cloud Adapter Layer 1220 also ensures that each company specific infrastructure (i.e., resources) are fully isolated from each other using the MT platform. Cloud resource orchestration layer 1230 is a core engine of Wheel Manager described herein. Cloud resource orchestration layer 1230 includes four individual modules that may be unified with a common policy framework and provisions the AppTop resources for each specific user.

An AppTop Desktop Provisioning Service 1232 is responsible for provisioning (i.e., preparing and equipping a network to allow it to provide services to users) the individual desktops (AppTop base OS's or AppTop appliances) for users. When a user session is started, the AppTop Desktop Provisioning Service 1232 may automatically launch the VM based on the specifications of the user entitlements. User entitlements may include specifications such as the type of AppTop appliance (e.g., Wheel, Windows or Linux), size of the resources (e.g., CPU, Memory, Disk type), and/or type of the display protocol (i.e., each AppTop appliance comes fully preconfigured with the type of the display protocol that is enabled for the user (e.g., VideoOverIP or RDP for Windows, NX for Linux etc)). In addition, each AppTop appliance may also be preconfigured with the protocol client and connection specific settings to serve apps from the corresponding App Terminal services sessions (e.g., MS RDS for Windows+LTSP or NX terminal services for Linux). AppTop Desktop Provisioning Service 1232 may also provide a link to a User Store service 1238 (described later) (i.e., each AppTop appliance may come pre-provisioned with the user store virtualization drivers that allows the AppTop appliance to connect with user specific User Stores 1238 (e.g., Wheel or 3rd party such as DropBox, etc)).

An App Publishing Service 1234 is a combination of the Microsoft RDS (Remote Desktop Services) and Linux Terminal Service and allows the delivery of Windows apps and Linux Apps to one of the AppTop bases. App Publishing Service 1234 may be fully integrated into the “Store” for the list of available apps, App Publishing Service 1234 for Windows may be powered by a combination of MS RDS services+App-V technologies. App Publishing Service 1234 for Linux may be powered by open source NXserver or LTSP services. App Publishing Service 1234 may also provide the API for the individual developers (referred to as Publishers) to publish their Windows or Linux apps to the corresponding publishing service solutions.

Continuing with FIG. 12, a SaaS (“software as a service”) aggregation service 1236 allows the publishing of SaaS applications (e.g., SalesForce, Facebook, etc.) into an AppTop appliance. The SaaS aggregation service 1236 provides the full Access Control, SSO (“Single sign-on”) and also is linked to the User Store Service 1238. In other words, if a user tries to download a SalesForce document, it may be automatically saved to the AppTop User Store Service 1238, which may then be accessed across all other AppTop appliances, or users may simply launch the user store directly from their device.

User Store service 1238 is responsible for accessing the native User Store (most likely hosted on Amazon S3 or other file system based service) or connecting to any of the available external User Stores, such as DropBox. User Store service 1238 works closely with the Desktop Publishing Service and App Publishing Service 1234 so that they automatically are provisioned using user profile virtualization technologies so that they may be automatically connected with the user specified. User Store.

Store 1240 is the central repository for end users to subscribe to the different AppTop appliances with their choice of base, choice of app (e.g. Windows, Linux or SaaS), and a choice of the user stores. Similarly, the store 1240 is the central place for the publishers to publish their applications for end user subscriptions with their application package, pricing etc. Embodiments may also include a community service called “App Request” where end users can send feedback with different app requests or enhancements and how much they are willing to pay so that publishing community may act up on it. The store 1240 may also facilitate a transaction based fee service for the platform where the publisher agrees to pay a percentage of their subscription fees. In addition, embodiments may include a base hosting fee for the type of application, which may be waived if the publisher has exceeded the threshold customer base. Embodiments of the store 1240 may allow for different monetization schemes such as “Ad based” business models.

AAA/Policy engine 1250 may support a simple user/password registrations, where the usernames are their email addresses. Because this is a user-centric service, each user can sign up with their own credentials. Other embodiments may support “OpenID” framework and/or SAML (“Security assertion markup language”) based authentication. In terms of the policy, users may self-govern their policy based cm their self-provisioning of the store 1240 resources. In embodiments built for SMB/enterprises, a more sophisticated AAA system with the support for AD, PKI, two-factor authentication, authorization and versatile policy management systems may be provided.

Operations Support System and Business Support System (OSS/BSS) services 1260 provide the management, monitoring and billing services for the AppTop service, OSS or management services 1260 is responsible for proactive monitoring of the various components and report alerts for any preventive and corrective actions. Examples of this may include, but are not limited to, individual services running out of capacity, services down, user login failed, etc., all ranked by severity, date/time, etc.

In general, report alerts may include four types of components: (1) system level alerts, which may only be for the service administrators in certain embodiments, but may also be exposed to the SMB customers as relevant to their specific company but may not be visible; (2) user level alerts, which may be the only thing that is exposed to the end users of the service and has detailed information about the usage activity, store visits, AppTop subscriptions, actual usage, etc.; (3) publisher level alerts, where publishers will keep track of their activity in terms of their contributions to the Wheel Store, their user subscriptions etc.; and (4) administrator level alerts, which is exposed to service administrators in the alpha release. In certain embodiments, this may be made available to SMB company specific administrators. BSS or billing services is integrated into the store subscription models. In addition, this service provides the end users with a self-service function to review and pay their bills using third party credit card authorization services or PayPal like services.

User Portal 1270 (i.e., AppTop User Portal) is the main gateway for the end users and publishers for the AppTop service and where users may subscribe to the Store AppTop appliances and manage their entire service. Publishers may also be able to publish their applications and manage them. In addition, the portal may also provide a launchpad for accessing the different AppTop appliances that are provisioned for a user. In embodiments disclosed herein, the AppTop portal is designed such that it adapts the user experience to the type of device the user is accessing, which results in the best user experience. User Portal 1270 may be guided by two helper services, (1) Dynamic AppTop composition service, which works with the Cloud Orchestration service models (i.e., 1232, 1234, 1236, and 1238) and (2) Device Rendering Service, which adapts the user experience tied to a device.

FIG. 13 depicts an initial or home interface 1300 provided by an application implementation for providing cloud-based cross-platform application stores for internet computing devices in accordance with one or more embodiments of the present disclosure. The interface 1300 shown may be customized with different skins; the view shown may be a default view. An interface 1300 in accordance with one or more embodiments herein may be built with HTML5. Touch-screen or double click may launch the system app in a display window on the mobile device (and provide the interface 1300 shown in FIG. 13). Users may also group apps to be combined into one display window. Clicking on the “Docs” icon (or other parts of user store) may launch a document with the corresponding app that is published to the user or if the user has a local app on the device. Embodiments may automatically download the document and open the document in a local window.

Thus, embodiments described herein create a unique market place between application developers, application provisioning and delivering, vendors, cloud computing and/or service provider vendors, and end users (either consumers or businesses). This marketplace guarantees that the application is delivered to end users at the lowest cost, highest security and performance, based on the embodiments described, herein. Overall, embodiments described herein allow users to run any app on any device securely and with low-cost of resources, either locally on a device or from the cloud.

The above description is for the purpose of teaching the person of ordinary skill in the art how to practice the present invention, and it is not intended to detail all those obvious modifications and variations of it which will become apparent to the skilled worker upon reading the description. It is intended, however, that all such obvious modifications and variations be included within the scope of the present invention, which is defined by the following claims. The claims are intended to cover the claimed components and steps in any sequence which is effective to meet the objectives there intended, unless the context specifically indicates the contrary.

What is claimed is:

1. A method of accessing an application on an internet computing device, the method comprising:
deploying a cross-platform application store server; and
accessing one or more applications in either of two modes:
a first mode comprising running in a cloud one or more multi-platform applications in an application container, and remotely displaying the applications using a display protocol; or
a second mode comprising running by proxy one or more local applications on a device in a secure application container.

2. The method of claim 1, further comprising using one or more of emulation, simulation, terminal services virtualization, and/or SaaS gateway connection for running in the first mode.

3. The method of claim 1 further comprising wrapping individual applications to be securely deployed inside an application on the device for running in the second mode.

4. The method of claim 1, further comprising using a proxy plug-in for securing native and public applications for running in the second mode.

5. The method of claim 1, further comprising creating a single container for all of the applications for running in the second mode.

6. The method of claim 1, further comprising authenticating user credentials before allowing access of applications.

7. The method of claim 6, further comprising connecting to corporate authentication, authorization, and auditing servers for user authentication.

8. The method of claim 1, further comprising automatically selecting either the first mode or the second mode based on one or more application delivery mechanisms.

9. The method of claim 1, further comprising providing user access from any HTML5 device for running in the first mode.

10. An interne computing device comprising:
an application store server that is deployable in either of two modes:
a local mode configured to create a secure application container and proxy for local applications to run on the device; or
a cloud mode configured to run in an application container and remotely display multi-platform applications on the device.

11. The device of claim 10, wherein the cloud mode uses one or more delivery mechanisms including emulation, simulation, terminal services, virtualization, and/or SaaS gate way connection.

12. The device of claim 10, wherein individual applications are wrapped and deployed inside a single application container on the device in the local mode.

13. The device of claim 10, wherein deployment of the application prompts a requirement for user authentication before allowing access to either local applications run on the device or multi-platform applications run in the cloud.

14. The device of claim 10, wherein deployment in either the local mode or the cloud mode is automatically selected based on one or more application delivery mechanisms.

15. An application platform for running on an internet computing device, the application platform comprising:
a desktop provisioning service module that is configured for provisioning individual desktops for users;
an application publishing service module configured to allow delivery of Windows apps and Linux Apps to users;
an aggregation service module configured to allow publishing of software-as-a-service applications into an appliance; and
a user store service module configured for provisioning a native user store or connecting to any available external user stores.

16. The application platform of claim 15, further comprising a cloud adaptor and vCompany MT layer that performs vCompute, vStorage, vNetwork, vSecurity, vOSS/BSS services with individual cloud specific API's plugged in.

17. The application platform of claim 15, further composing OSS/BSS Services that provides management, monitoring, and billing services.

18. The application platform of claim 15, further comprising a user portal configured as a main gateway for end users and publishers ha the application delivery service.
